(19) United States
(12) Patent Application Publication
(10) Pub. No.: US 2019/0293024 A1
(43) Pub. Date: Sep. 26, 2019

(54) HYDROGEN-FUELED SUPERSONIC TURBORAMJET ENGINE

(71) Applicant: Global Reach Aerospace LLC, Austin, TX (US)

(72) Inventor: Preston Henry Carter, Austin, TX (US)

(21) Appl. No.: 16/284,981

(22) Filed: Feb. 25, 2019

Related U.S. Application Data
(60) Provisional application No. 62/634,281, filed on Feb. 23, 2018.
(60) Provisional application No. 62/634,297, filed on Feb. 23, 2018.

(51) Int. Cl. F02K 3/00; F02K 7/16; F02C 7/16; F02C 7/224

(52) U.S. Cl. CPC F02K 3/00; F02K 7/16; F05D 2220/10; F02C 7/224; F02C 7/16

(57) ABSTRACT

Provided are systems and methods for a hydrogen-fueled supersonic turbojet engine system comprising: an inlet; combustor; fuel storage; high-pressure turbine and low-pressure turbine wherein the initial pressure of the high-pressure turbine is greater than the initial-pressure of the low-pressure turbine; a compressor operably attached to the low-pressure turbine; and a plurality of stream lines configured to circulate cryogenic liquid molecular hydrogen fuel through a plurality of heat exchangers positioned in the airframe and a precooler in the engine, wherein the plurality of fuel stream lines connects the fuel storage to the low-pressure and high-pressure turbines and the combustor.

### CROSS-REFERENCE TO RELATED APPLICATIONS

This application claims priority to U.S. Provisional Application No. 62/634,892, filed Feb. 23, 2018, entitled LARGE TEST AREA COMPRESSED AIR WIND TUNNEL, and U.S. Provisional Application No. 62/634,297 entitled SUPERSONIC HYDROGEN FUEL TURBOJET ENGINE, filed Feb. 23, 2018.

### BACKGROUND

### 1. Field

The present disclosure generally relates to the field of aerospace transportation, and more specifically, to a multi-stage hypersonic atmospheric air-breathing aircraft, its fuel systems, cooling systems, and propulsion systems.

### 2. Description of the Related Art

The supersonic jet engine market comprises few designs. Some early supersonic aircraft, including the first, relied on rocket power to augment thrust. Rockets, however, consume fuel at a high rate so flight times were short. Early turbojet engines were more fuel-efficient than rockets but did not have enough thrust for supersonic flight, so some experimental aircraft were fitted with both turbojet engines for low-speed flight and rocket engines for supersonic flight. The invention of the afterburner, in which additional fuel is burned in the jet exhaust, removed the need for rockets for supersonic flight. Another variant, the turbofan engine or high-bypass-fan engine, was later developed, wherein the majority of incoming air is passed around the engine core. These engines are not afterburning with the objective being increased fuel efficiency for use in subsonic commercial flight. All modern commercial jet aircraft today use high-bypass jet engines. Rounding out the family of modern jet engines is the turboprop, which uses a small turbofan engine attached to which is a gearbox and large propeller. Although operating at a much slower speed than the other variants due to the large external propeller, it is the most fuel efficient. All these variants use some form of jet fuel which is petroleum-based.

Modern supersonic aircraft typically use low-bypass turbojet engines. Although not the most fuel efficient, they can operate throughout a range of both subsonic and supersonic speeds. The largest operating range was achieved by the Pratt & Whitney J-58 engine utilized on the Lockheed SR-71 Blackbird. At subsonic speeds the J-58 operated as a low-bypass turbojet, and at supersonic speeds the J-58 operated as a high-bypass afterburning turbojet. Air was directed either into or around the engine core by the use of hydraulically actuated gates. This allowed the SR-71 to fly up to Mach 3.5 at 85,000 feet.

Another high-speed aircraft engine is the ramjet. Ramjets were first designed in the 1950's and are intended to operate only at supersonic speeds, meaning in excess of Mach 1. Pure ramjets have no rotating machinery such as turbine compressor fans and consequently depend on incoming (ram) air to operate. The removal of internal rotating machinery removes the risk of component failure at high speed and therefore high temperature when active cooling is not available. The early pure ramjets were essentially venturi-tubes into which fuel was injected and ignited in the hot airflow. Ramjets need to be moving at high-speed, typically above Mach 1, before they will begin generating thrust and continue to operate self-sustainably.

Variations of the jet engine have been designed for different flight conditions and mission requirements. As demand increased over time for ever greater speed, altitude and range, prior art jet engines have become increasingly complex and costly. Some jet engines have a high level of compression and bypass to allow for acceleration up to and through the transonic range (e.g., U.S. Pat. No. 4,294,068 to Klees) while others are designed for propulsion only at supersonic speeds (e.g., U.S. Pat. No. 3,974,648 to Kepler). Engines designed with the features necessary to perform across the entire desired envelope of speeds, altitudes and ranges are few in number, costly, complex, inefficient, are consequently essentially for military-use, and consume only petroleum as a fuel.

There is now a need for a form of jet engine which can power a high-supersonic to low-hypersonic aircraft, meaning it is capable of operating at speeds up to and including Mach 5, for air-breathing atmospheric flight, at altitudes up to 120,000 feet, using cryogenic liquid molecular hydrogen (LH₂) as a fuel.

### SUMMARY

The following is a non-exhaustive listing of some aspects of the present techniques. These and other aspects are described in the following disclosure.

Some aspects include a Hydrogen-Fueled Supersonic Turboramjet Engine designed to operate in a range of both subsonic and supersonic speeds.

In some aspects of the present invention, cryogenic liquid molecular hydrogen (LH₂) is used as a fuel for the Hydrogen-Fueled Supersonic Turboramjet Engine.

In some aspects of the present disclosure, cryogenic liquid molecular hydrogen (LH₂) is circulated through the Hydrogen-Fueled Supersonic Turboramjet Engine inlet to precool the air.

In some aspects of the present disclosure, cryogenic liquid molecular hydrogen (LH₂) is circulated through the Hydrogen-Fueled Supersonic Turboramjet Engine and airframe to actively cool aerodynamically heated surfaces.

In some aspects of the present disclosure, cryogenic liquid molecular hydrogen (LH₂) is circulated through the Hydrogen-Fueled Supersonic Turboramjet Engine to turn rotating machinery.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is an embodiment of the Hydrogen-Fueled Supersonic Turboramjet Engine with a schematic of the hydrogen fueling and cooling loop.

FIG. 2 is a detailed schematic of the Hydrogen-Fueled Supersonic Turboramjet Engine with hydraulically-actuated gates positioned to divert air toward and away from precoolers.

FIG. 3 is an estimate of performance for the Hydrogen-Fueled Supersonic Turboramjet Engine according to the disclosure herein.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

The present techniques relate to engines useful in a variety of contexts, including those described in U.S. patent application Ser. No. 16/269,362, entitled Multi-Stage, Liquid Hydrogen-Based Aerospace System, filed Feb. 6, 2019, which is herein incorporated by reference for all purposes. In some embodiments, the presently described engines may be tested in a testing facility described in U.S. Provisional Patent Application 62/634,281, entitled Large Test Area Compressed Air Wind Tunnel, filed Feb. 23, 2018, which is also herein incorporated by reference for all purposes. U.S. Provisional Patent Application 62/626,977 discloses a multi-stage aerospace system into which certain embodiments of the engine of this disclosure can be incorporated. U.S. Provisional Patent Application 62/634,281 discloses a supersonic testing facility in which the engine of this disclosure can be tested.

To mitigate the problems described herein, the inventors had to both invent solutions and, in some cases just as importantly, recognize problems overlooked (or not yet foreseen) by others in the field of supersonic combined-cycle engine design. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional embodiments described herein or provide every benefit described herein. That said, improvements that solve various permutations of these problems are described below.

The present disclosure includes a Hydrogen-Fueled Supersonic Turboramjet Engine intended for use in at least a high-speed air transport vehicle (the applicant terms this vehicle “Hypersoar” and for purposes of this disclosure is termed “Atmospheric Cruise Vehicle”). Applicant terms one embodiment of the engine disclosed herein “Cooljet” and for purposes of this disclosure the plurality of embodiments is termed “Hydrogen-Fueled Supersonic Turboramjet Engine”. This embodiment is a cryogenic liquid molecular hydrogen (LH₂) fueled combined-cycle turboramjet engine designed for flight up to and including Mach 5.

During high-speed flight, portions of the Atmospheric Cruise Vehicle will experience aerodynamic heating and will need active cooling, and some components of the Hydrogen-Fueled Supersonic Turboramjet Engine will also experience heating and need active cooling. In some embodiments, the preferred cooling liquid is cryogenic liquid molecular hydrogen (LH₂) which will be circulated through the airframe and engines. Circulation can be via appropriate piping, tubing or other stream line, and can be a portion of the fuel circulation system or a separate loop circulating cooling working fluid. LH₂ expands and vaporizes when it is heated. In this embodiment, the expansion will be used to drive the Hydrogen-Fueled Supersonic Turboramjet Engine's compressor turbines and fuel pumps, after which the vaporized LH₂ will be burned as fuel in the burner, also called the combustor.

At speeds in excess of Mach 3, the stagnation temperature of the air entering the Hydrogen-Fueled Supersonic Turboramjet Engine may exceed the practical limits of materials. The Hydrogen-Fueled Supersonic Turboramjet Engine is protected from high inlet stagnation temperatures by injection of cryogenic LH₂ into the inlet air prior to the time it enters the first compressor. In this embodiment of the Hydrogen-Fueled Supersonic Turboramjet Engine, cryogenic LH₂ is also circulated through the hot sections of the engine to cool its components and structures.

In some embodiments, the use of cryogenic LH₂ as a fuel enables use of already commercialized alloys in the airframe and engine due to active cooling of components due to the capacity of cryogenic LH₂ to absorb unwanted heat given that it is stored as a liquid at a temperature of approximately 20 degrees Kelvin (20° K).

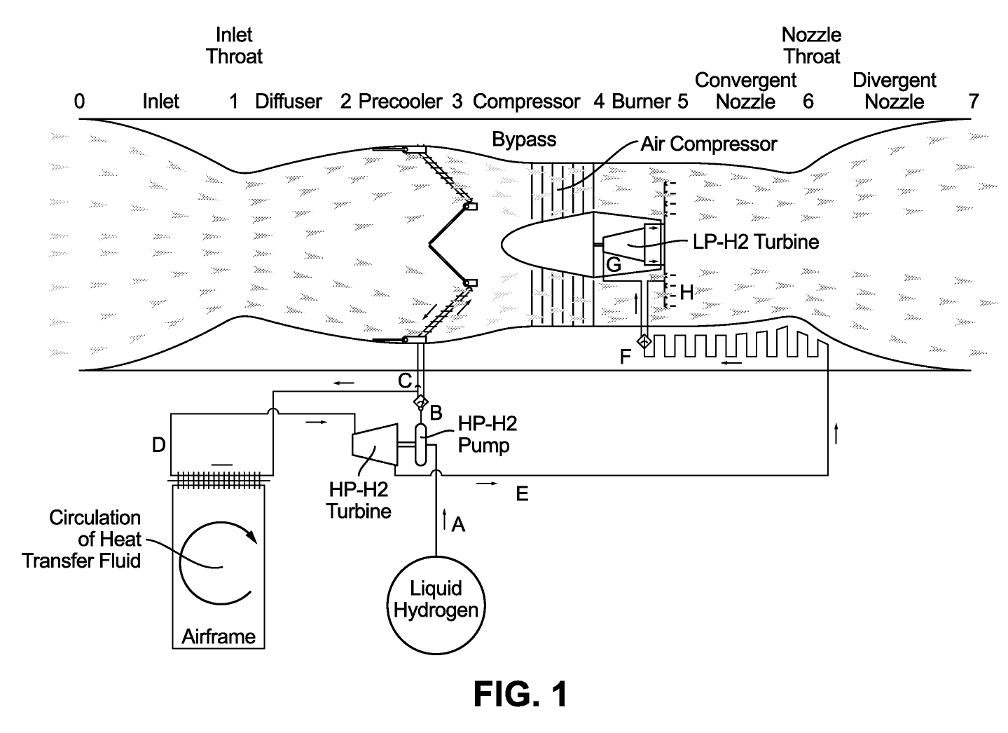

This embodiment, the Hydrogen-Fueled Supersonic Turboramjet Engine, has several modes of operation. FIG. 1 is a schematic describing the layout of one embodiment. The numbered stations in the figure refer to the major states of air passing through the engine. The lettered stations in the figure refer to the progress of the cryogenic LH₂ from liquid storage through to the engine's burner/combustor. This figure depicts the engine in high-speed cruise mode with air being diverted through the precooler. The figure should be considered an uninstalled engine. Features of an installed engine regarding control of the inlets and nozzles have been omitted in the figure but are contemplated in implementations of embodiments of the Hydrogen-Fueled Supersonic Turboramjet Engine as installed in an airframe. Also, the routing and utilization of air and power vented from the Hydrogen-Fueled Supersonic Turboramjet Engine for airframe purposes are not shown but are contemplated in implementations of embodiments as installed in an airframe.

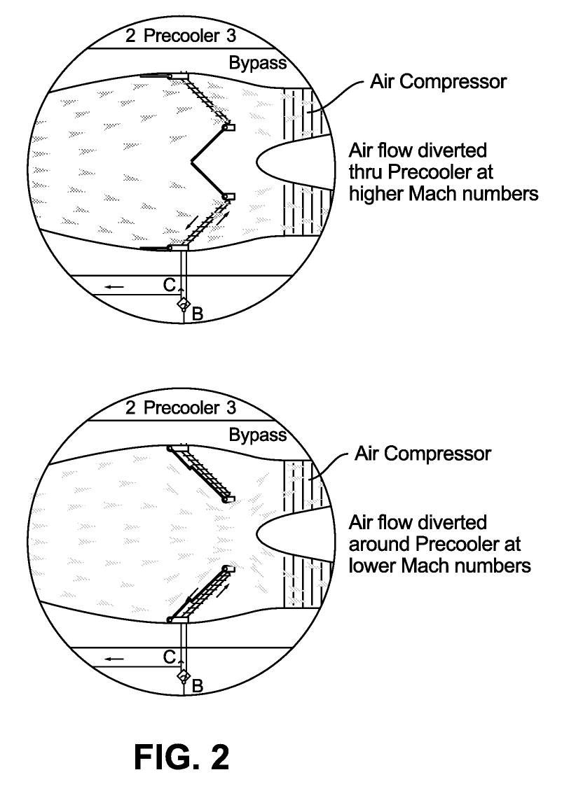

In FIG. 1, supersonic air enters via the inlet at station 0. Compression of the air at the throat, station 1, transitions it to subsonic flow. At flight speeds greater than Mach 3, the stagnation temperature within the diffuser becomes too great for portions of the compressor. Under these conditions air flow in the diffuser is directed through the precooler heat exchanger. This cools the air sufficiently to protect the compressor. There are opportunities at lower speeds to use this precooler to densify air entering in the engine for thrust augmentation; however, the primary purpose of the precooler is to protect the compressor from high stagnation temperatures at higher cruise speeds. The schematic illustrates the precooler in a configuration that diverts air through the heat exchanger. The schematics of FIG. 2 illustrate the high and low speed number configurations of the precooler.

In FIG. 1, conditioned air from the diffuser flows into the compressor, station 3-4. The compressor has a modest compression ratio (e.g., less than 5-times). While in high-speed flight, most compression comes from ram air, mechanical compression is advantageous at lower Mach numbers and required for subsonic flight. The amount of mechanical compression to be designed into the engine is a trade-off between the level of pre-cooling required at high Mach numbers and performance of the engine at low Mach numbers. Almost any compression is sufficient to give the engine acceptable performance for subsonic cruise, terminal area maneuvering and landing. While higher mechanical compression reduces fuel consumption at lower Mach number, at Mach 3 and above, if the compression ratio is too high, the exit temperatures from the compressor can exceed the working temperature of the compressor.

In FIG. 1, as air exits the compressor it is directed into the combustor, station 4-5. Vaporized hydrogen gas is then injected into the burner/combustor where it is ignited. By the time hydrogen is injected into the burner/combustor it has been heated to nearly the temperature of the air exiting the compressor through the use of heat exchangers wherein it is used by the vehicle and the engine to remove heat from critical areas.

Cryogenic LH₂ is stored as a liquid at approximately 20° K and is injected into the burner/combustor at temperatures up to 1,500° K. The latent heat of vaporization is 452 KJ/kg and the specific heat of hydrogen is 14 KJ/(kg° K). Heating LH₂ from 20° K to 1,500° K will absorb approximately 21,172 KJ/kg (452+14 (1,500° K−20° K)) of heat. The heat absorbed by the LH₂ is mixed with air for combustion and permanently removed from the vehicle.

In some embodiments, additives are added to the LH₂ to increase the latent heat or the specific heat of the mixture to enhance the cooling efficiency. The additives can be in form of solids or liquids. In some embodiments, the additives further enhance the burning efficiency of the LH₂ at the combustor.

In some embodiments, the latent heat and the specific heat of the working fluid are in the range of 200-20000 KJ/kg and 5-500 KJ/kg, respectively. This working fluid operates with high latent heat, and are considered sufficiently high for purposes of this disclosure if within the specified ranges. In some embodiments, the working fluid is the fuel.

In FIG. 1, the hot gas exits the burner/combustor and is accelerated in the convergent-divergent nozzle to produce thrust. To prevent excess gaseous hydrogen in the exhaust, this embodiment is designed to run at an equivalence ratio of 1 or less. In this way complete combustion of hydrogen gas in the burner/combustor is assured and fuel economy is maximized.

Using cryogenic LH₂ to cool the airframe and engine, and as a fuel for combustion, is a feature of this embodiment worth highlighting. The flow of cryogenic LH₂ from storage to the burner/combustor is illustrated in the embodiment shown in FIG. 1 as stations lettered from A to H. Cryogenic LH₂ is stored as a liquid in the vehicle, station A. A fuel pump pressurizes the cryogenic LH₂, A to B, to high enough pressures to facilitate mass flow and heat transfer requirements. If the precooler is operational, cryogenic LH₂ is routed through the precooler, B to C. If the precooler is not required or does not need the full flow of cryogenic LH₂ available, it is routed to an airframe heat exchanger, B to D. Heat is gathered from critical areas of the airframe and concentrated at the heat exchanger. The heated and expanding hydrogen is used to drive rotating machinery in the Hydrogen-Fueled Supersonic Turboramjet Engine. A benefit of using cryogenic LH₂ in this way is that it removes heat from the vehicle.

Once hydrogen exits the high-pressure turbine it is routed to the hot sections for use as a coolant, and then routed to the low-pressure turbine which drives the compressor. After the hydrogen exits the low-pressure turbine, it is now at the required temperature and is injected into the burner/combustor where it is mixed with air, ignited, and produces thrust.

In one embodiment shown in FIG. 1, the initial pressure P_{1 High} of the high-pressure turbine is the pressure at the point the hydrogen reaches the high-pressure turbine. The hydrogen exits the high-pressure turbine at a pressure P_{2 High} lower than P_{1 High}. The initial pressure of the low-pressure turbine is the pressure at the point the hydrogen reaches the low-pressure turbine, a value P_{1 Low} at or below P_{2 High}. The hydrogen exits the low-pressure turbine at a lower pressure P_{2 Low} still. The ratios P_{1 High}/P_{2 High} and P_{1 Low}/P_{2 Low} are set at sufficient values to allow for fuel flow and to drive the rotating machinery comprised of pumps and the compressors.

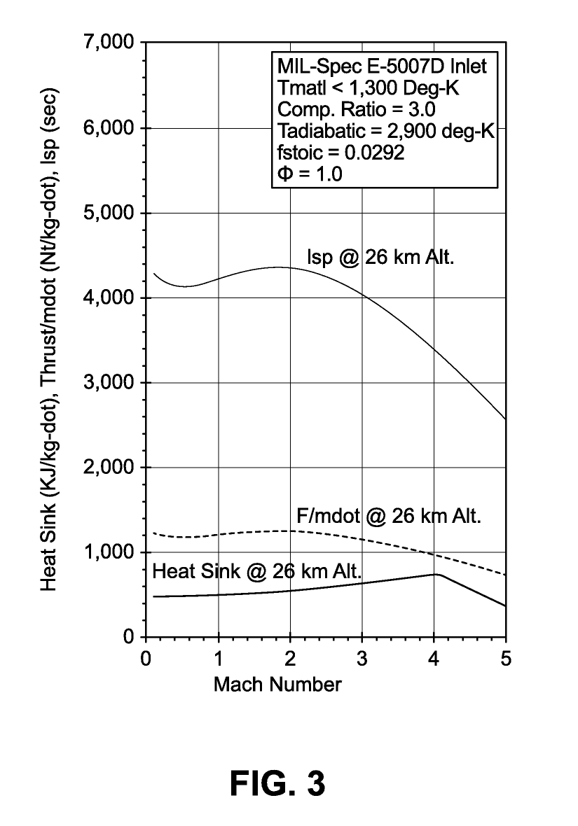

FIG. 3 provides the estimated performance of Hydrogen-Fueled Supersonic Turboramjet Engine assuming state of the art materials, stoichiometric combustion, and a compression ratio of 3 times. This chart provides the estimated specific thrust and specific impulse. This chart also provides the estimated heat sink provided for the vehicle as a ratio of the air mass rate through the Hydrogen-Fueled Supersonic Turboramjet Engine assuming a stoichiometric fuel and air ratio.

In some embodiments for purposes of this disclosure, the optimal performance is represented by at least specific thrust above 500 Nt/(kg−dot) or specific impulse above 2000 sec. Below Mach 1, the engine operates with acceptable functionality, defined as at least 20% of the optimal performance. The performance of Hydrogen-Fueled Supersonic Turboramjet Engine is a function of multiple factors, including but not limited to efficiency of combustor, turbines, heat exchangers, and compressor. Efficiency of each of these parts also depend on many factors. For example, the efficiency of combustor depends on many factors, including but not limited to oxygen to fuel ratio, mix of oxygen with fuel, combustor temperature, and density of fuel.

The embodiment previously described, routes cryogenic LH₂ for cooling throughout the Atmospheric Cruise Vehicle and the Hydrogen-Fueled Supersonic Turboramjet Engine. This approach, in some implementations, requires substantially all materials of the flow path be compatible with cryogenic LH₂ including the pumps, heat exchangers, turbines, flow lines, and seals. There are several reliable materials for use with cryogenic LH₂ such as austenitic chrome-nickel steel with a high nickel content and several aluminum alloys with good weldability.

The Hydrogen-Fueled Supersonic Turboramjet Engine is designed to power at least the Atmospheric Cruise Vehicle and is a relatively simple low-compression engine, fueled by cryogenic liquid molecular hydrogen (LH₂), which uses a precooler to protect the compressor from high temperatures during high-speed flight, and uses engine and airframe heat in expansion turbines to drive its pumps and compressors. Being a second-stage, the Atmospheric Cruise Vehicle does not require operation of the Hydrogen-Fueled Supersonic Turboramjet Engine for the initial departure, climb and acceleration. Therefore, it is designed to provide optimal performance at speeds exceeding Mach 1 up to and including Mach 5 and at subsonic speeds during descent and landing, thereby providing robust mission flexibility while remaining mechanically simple. Importantly, the Hydrogen-Fueled Supersonic Turboramjet Engine manages the use of cryogenic LH₂ fuel in a manner to cool itself and the airframe during sustained high-speed flight.

Certain aspects of this disclosure include a Hydrogen-Fueled Supersonic Turboramjet Engine system comprising: an inlet; combustor; fuel storage; high-pressure turbine and low-pressure turbine wherein the initial pressure of the high-pressure turbine is greater than the initial pressure of the low-pressure turbine; a compressor operably attached to the low-pressure turbine; and a plurality of stream lines configured to circulate fuel through a plurality of heat exchangers positioned in airframe and a precooler, wherein the plurality of fuel stream lines connects the fuel storage to the low-pressure and high-pressure turbines and the burner/combustor.

Certain aspects of this disclosure include the system above, wherein the circulated fuel is cryogenic liquid molecular hydrogen (LH₂)

Certain aspects of this disclosure include the system above, wherein the use of fuel with high latent heat enables use of currently available commercialized alloys in the airframe and the engine up to Mach 5 due to dynamic cooling of the airframe and the engine through the plurality of heat exchangers using the LH₂ fuel as a heat sink.

Certain aspects of this disclosure include the system above, wherein the cryogenic LH₂ fuel is configured to be used as a heat sink circulating through the plurality of heat exchangers, absorbing heat by an increase in the fuel temperature.

Certain aspects of this disclosure include the system above, wherein the cryogenic LH₂ fuel is mixed with air upon exiting the low-pressure turbine while entering the burner/combustor.

Certain aspects of this disclosure include the system above, wherein the Hydrogen-Fueled Supersonic Turboramjet Engine is configured to provide the optimal performance at flight speeds above Mach 1 up to and including Mach 5, with acceptable functionality at subsonic speeds.

Certain aspects of this disclosure include the system above, wherein, when above Mach 3. the precooler reduces the stagnation air temperature before it enters the compressor. The stagnation air temperature is also the total air temperature and can be measured by a temperature probe mounted on the surface of the aircraft. The probe can be designed to bring the air to rest relative to the aircraft. As the air is brought to rest, kinetic energy is converted to internal energy. The air is compressed and experiences an adiabatic increase in temperature. This causes total air temperature is higher than the static (or ambient) air temperature.

Certain aspects of this disclosure include the system above, wherein, above Mach 3 airflow is diverted through the precooler, while below Mach 3 airflow is diverted around the precooler.

Certain aspects of this disclosure include a Hydrogen-Fueled Supersonic Turboramjet Engine system comprising: an inlet; combustor; fuel storage; high-pressure turbine and low-pressure turbine; compressor; a first plurality of stream lines configured to circulate fuel through a first plurality of heat exchangers, wherein the first plurality of stream lines connects the fuel storage to the combustor; and a second plurality of stream lines is configured to circulate a working fluid through a second plurality of heat exchangers, including the first plurality of heat exchangers, at least some positioned in the airframe, and some in the precooler, wherein the second plurality of stream lines connects the compressor to the low-pressure and the high-pressure turbines.

Certain aspects of this disclosure include the Hydrogen-Fueled Supersonic Turboramjet Engine system above, wherein the use of working fluid with high latent heat enables use of currently available commercialized alloys to Mach 5 due to active cooling through the plurality of heat exchangers using the working fluid as a heat sink.

Certain aspects of this disclosure include a Hydrogen-Fueled Supersonic Turbojet Engine system above, wherein the LH₂ fuel is configured to be used as a heat sink circulating through the plurality of heat exchangers, absorbing heat by an increase in the working fluid temperature.

Certain aspects of this disclosure include a Hydrogen-Fueled Supersonic Turbojet Engine system above, wherein the engine is configured to provide the optimal performance from Mach 2 up to Mach 5, with acceptable functionality at subsonic speeds.

Certain aspects of this disclosure include the Hydrogen-Fueled Supersonic Turboramjet Engine above, wherein airflow is diverted through the precooler at and above Mach 3, while airflow is diverted around the precooler below Mach 3.

Certain aspects of this disclosure include a method of operating a Hydrogen-Fueled Supersonic Turboramjet Engine to be able to fly at speeds up to and including Mach 5 while also developing adequate thrust for subsonic flight, comprising: an inlet; combustor; fuel storage; high-pressure and low-pressure turbines; wherein the initial pressure of the high-pressure turbine is greater than the initial pressure of the low-pressure turbine; a compressor operably attached to the low-pressure turbine; and a plurality of stream lines configured to circulate fuel through a plurality of heat exchangers some positioned in airframe and some in the precooler, wherein the plurality of fuel stream lines connects the fuel storage to the low-pressure and high-pressure turbines and the combustor.

Certain aspects of this disclosure include the method above, wherein the circulated fuel is cryogenic liquid molecular hydrogen (LH₂)

Certain aspects of this disclosure include the method above, wherein the use of fuel with high latent heat enables use of already commercialized alloys in the airframe and the engine up to Mach 5 due to active cooling of the airframe and the engine through the plurality of heat exchangers using the LH₂ fuel as a heat sink.

Certain aspects of this disclosure include the method above, wherein the LH₂ fuel is configured to be used as a heat sink circulating through the plurality of heat exchangers, absorbing heat by at least latent heat of evaporation or increase in the fuel temperature.

Certain aspects of this disclosure include the method above, wherein above Mach 3, the precooler reduces the stagnation air temperature to practical limits of engine materials before it reaches the engine.

Certain aspects of this disclosure include the method above, wherein airflow is diverted through the precooler above Mach 3, while the airflow is diverted around the precooler below Mach 3.

A simple representation for thrust is given with:

F=\dot{m}[(1−ϕf_{stoic})u₇−u₀]+(P₇−P₀)A₇

Where: \dot{m}=dmair/dt
ϕ is the fuel equivalence ratio,
f_{stoic} is the fuel to air ratio at stoichiometric conditions,
u₇ is exhaust velocity at the exit of the engine,
u₀ is air velocity entering the inlet,
P₇ is pressure at the exit of the engine,
P0 is pressure entering the engine,
A₇ is the exit area of the nozzle.
Assuming the simplified, ideal case, in which the exhaust is fully expanded to atmospheric pressure, P₇=P₀, and assume the mass flow of the fuel is negligible, (1−ϕf_{stoic})≈1, the thrust equation becomes:

F=\dot{m}[u₇−u₀]

Arranging terms,

$$\frac{F}{\dot{m} {a}_{0}} = {M}_{0} [ \frac{{u}_{7}}{{u}_{0}} - 1 ] , \\ Define \text{:} {I}_{sp} = \frac{F}{{g}_{0} φ {f}_{stoic} \dot{m}}$$

Where: u₀=M₀a₀
M is Mach number,
a is the speed of sound, a=√γRT,
γ is the ratio of specific heats,
R is the gas constant,
Iₛₚ is specific impulse,
g₀ is the gravitation acceleration constant.
To find u₇/u, observe that:

0

$$\frac{{u}_{7}}{{u}_{0}} = \frac{{M}_{7}}{{M}_{0}} \sqrt{\frac{{T}_{7}}{{T}_{0}}}$$

We can define M₀ in terms of the free stream stagnation temperature

$$\frac{{T}_{t 0}}{{T}_{0}} = {θ}_{0} = ( 1 + \frac{( γ - 1 )}{2} {M}_{0}^{2} )$$

Solving for the free stream Mach number

$$\frac{{T}_{t 0}}{{T}_{0}} = {θ}_{0} = ( 1 + \frac{( γ - 1 )}{2} {M}_{0}^{2} )$$

Expressions for M7 can be derived from the stagnation temperature and pressure at the exit

$$\frac{{T}_{t 7}}{{T}_{7}} = ( 1 + \frac{( γ - 1 )}{2} {M}_{7}^{2} ) , \\ \frac{{P}_{t 7}}{{P}_{7}} = {( 1 + \frac{( γ - 1 )}{2} {M}_{7}^{2} )}^{\frac{γ}{γ - 1}}$$

Stagnation temperature at the exit can be defined with the temperature ratios

$$\frac{{T}_{t 7}}{{T}_{0}} = {θ}_{0} {τ}_{d} {τ}_{c} {τ}_{b} = {θ}_{0} {τ}_{d} {τ}_{c} {τ}_{b}$$

Where: τd, πd are defined as

$${T}_{t 3 / {T}_{t {0}^{′}}} {P}_{t 3 / {P}_{t {0}^{′}}}$$

τc, τc are defined as

$${T}_{t 4 / {T}_{t {3}^{′}}} {P}_{{t}^{4} / {P}_{t {3}^{′}}}$$

τ_{b} is defined as

$${T}_{t 5 / {T}_{t {0}^{′}}}$$

Assume a pre-cooler heat exchanger in the diffuser will limit the stagnation temperature at the compressor inlet temperature to Tₜ₃ₘₐₓ. For flight conditions in which Tₜ₃<Tₜ₃ₘₐₓ, τ_{d}=1.
For flight conditions with

$${T}_{t 3} > {T}_{t 3 max} , {τ}_{dd} = T t 3 max \text{/} {T}_{t 3}$$

and the pre-cooler heat exchanger will remove

$$\dot{hp} re \text{-} cooler = {\dot{m} Cp}_{air} ( {T}_{t 3} - {T}_{t 3 max} )$$

heat from the air flow.
Similarly, the stagnation pressure at the exit can be defined with the pressure ratios

$$\frac{{P}_{t 7}}{{P}_{0}} = {δ}_{0} {π}_{d} {π}_{c} , where \text{:} {δ}_{0} = {θ}_{0}^{\frac{γ}{γ - 1}} = {( 1 + \frac{( γ - 1 )}{2} {M}_{0}^{2} )}^{\frac{γ}{γ - 1}}$$

Following guidance from MIL-E-5007 D for inlet pressure loss, for M0<1, πd=1, and for 1≤M₀≤5, π_{d}=1−0.075(M₀−1)^{1.35}.
With the assumption, P7=P0, and with the relationship,

$$τ = {π}^{\frac{γ - 1}{γ}} ,$$

for adiabatic, isentropic processes:

$${( \frac{{P}_{t 7}}{{P}_{7}} )}^{\frac{γ}{γ - 1}} = \frac{{T}_{t 7}}{{T}_{0}} = {{θ}_{0} ( {π}_{d} {π}_{c} )}^{\frac{γ}{γ - 1}} = ( 1 + \frac{( γ - 1 )}{2} {M}_{7}^{2} )$$

$${M}_{7} = \sqrt{\frac{2}{( γ - 1 )}} \sqrt{{{θ}_{0} ( {π}_{d} {π}_{c} )}^{\frac{γ}{γ - 1}} - 1}$$

$$\frac{{M}_{7}}{{M}_{0}} = \sqrt{\frac{( {{θ}_{0} ( {π}_{d} {π}_{c} )}^{\frac{γ}{γ - 1}} - 1 )}{( {θ}_{0} - 1 )}}$$

### Therefore:

Using expressions for

$$\frac{{T}_{t 7}}{{T}_{7}} and \frac{{T}_{t 7}}{{T}_{0}}$$

$$\frac{{T}_{t 7}}{{T}_{0}} = \frac{{T}_{7}}{{T}_{t 7}} \frac{{T}_{t 7}}{{T}_{0}} = {τ}_{d} {τ}_{b}$$

Engine thrust can now be expressed in terms of flight conditions and design parameters:

$$\frac{F}{\dot{m} {a}_{0}} = {M}_{0} ⌊ \sqrt{\frac{( {{θ}_{0} ( {π}_{d} {π}_{c} )}^{\frac{γ}{γ - 1}} - 1 )}{( {θ}_{0} - 1 )} {τ}_{d} {τ}_{b}} - 1 ⌋$$

### Define:

$${τ}_{λ} = \frac{{T}_{t 5}}{{T}_{0}} ,$$

so that:

$${τ}_{λ} = {θ}_{0} {τ}_{d} {τ}_{c} {τ}_{b} , \\ {τ}_{b} = \frac{{τ}_{λ}}{{θ}_{0} {τ}_{d} {τ}_{c}}$$

$$\frac{F}{\dot{m}} = {M}_{0} \sqrt{γ {RT}_{0}} [ \sqrt{\frac{( {{θ}_{0} ( {π}_{d} {π}_{c} )}^{\frac{γ}{γ - 1}} - 1 )}{( {θ}_{0} - 1 )} \frac{{τ}_{λ}}{{{θ}_{0} ( {π}_{d} {π}_{c} )}^{\frac{γ}{γ - 1}}}} - 1 ]$$

### Stoichiometric Combustion:

2H2+(O2+3.76N2)ₐᵢᵣ→2H2O+3.76N2

$$AR = \frac{4.76 {Mole}_{air}}{2 {Mole}_{{H}_{2}}} = 2.38 \frac{mole}{mole}$$

Molecular weight of Air and Hydrogen are 29.0 kg/kmole and 2.02 kg/kmole:

$${AR}_{stoic} = 2.38 \frac{29.0 kg \text{/} kmole}{2.02 kg \text{/} kmole} = 34.2 \frac{kg}{kg}$$

$${f}_{stoic} = \frac{1}{{AR}_{stoic}} = 0.0292$$

How much heat sink, knowing fstoic and given \dot{m}, is available to the engine and airframe? If the injection temperature of the hydrogen into the combustor is assumed to have a design limited maximum of Tᵢₙⱼ₋ₘₐₓ, the total available heat sink in the fuel for inlet pre-cooling, engine cooling, and airframe cooling is

hH2|max=LH₂ Vaporization

+H₂ Heating from Boiling to Burner Injection temperature

+Work of LH₂ Pressurization+Work to Drive the Engine Compressor

$${h}_{H 2 \text{-} max} = φ {f}_{stoic} [ Δ {h}_{Vapor \text{-} H 2} + {C}_{{p}_{H 2}} ( {T}_{inj \text{-} max} - {T}_{boil \text{-} H 2} ) + \frac{Δ {P}_{LH 2}}{{ρ}_{LH 2}} ] + {T}_{0} {θ}_{0} {C}_{{p}_{air}} ( {( {π}_{d} {π}_{c} )}^{\frac{γ}{γ - 1}} - {τ}_{d} )$$

The maximum material temperature, Tₘₐₓ₋ₘₐₜₗ, will occur at the exit of the compressor, Tₜ₄. The Precooler heat draw can be expressed as:

$${\dot{h}}_{precooler} = \{ \begin{matrix}{T}_{t 4} < {T}_{max \text{-} matl} , & 0 \\ {T}_{t 4} > {T}_{max \text{-} matl} , & {mT}_{0} {θ}_{0} {C}_{{p}_{aiir}} ( {π}_{c}^{\frac{γ - 1}{γ}} - 1 )\end{matrix} \\ Where \text{:} {T}_{t 4} = {T}_{0} {θ}_{0} {π}_{c}^{\frac{γ - 1}{γ}}$$

There is an upper limit where enough fuel is not available to protect the compressor. In this case, the vehicle must limit its speed to prevent overheating the compressor, the engine must burn fuel rich into to provide more heat sink mass, or a portion of the air mass must be diverted from the compression to prevent excess heat from being exposed to the compressor and precooler. The precooler heat balance with fuel flow, at maximum conditions, can be expresses as:

$$\dot{m} φ {f}_{stoic} [ {C}_{{p}_{H 2}} ( {T}_{max \text{-} matl} - {T}_{boil \text{-} H 2} ) + Δ {h}_{Vapor \text{-} H 2} ] = \dot{m} {C}_{{p}_{air}} ( \frac{{T}_{max \text{-} matl}}{{π}_{c}^{\frac{γ - 1}{γ}}} - {T}_{0} {θ}_{0} )$$

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,” “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A hydrogen-fueled supersonic turboramjet engine system comprising:
an inlet;
a combustor;
a fuel storage;
a high-pressure turbine having an initial pressure, wherein the initial pressure is the pressure of circulated fuel as the circulated fuel contacts the high-pressure turbine and a low-pressure turbine having an initial pressure, wherein the initial pressure is the pressure of circulated fuel as a circulated fuel contacts the low-pressure turbine wherein the initial pressure of the high-pressure turbine is greater than the initial pressure of the low-pressure turbine;
a compressor operably attached to the low-pressure turbine; and
a plurality of stream lines configured to circulate fuel through a plurality of heat exchangers positioned in an airframe and a precooler, wherein the plurality of fuel stream lines connects the fuel storage to the low-pressure and high-pressure turbines and the combustor.

2. The system of claim 1, wherein the fuel is cryogenic liquid molecular hydrogen (LH₂).

3. The system of claim 1, wherein the fuel has at least high latent heat or specific heat, capable of active cooling of commercialized alloys in the airframe and the engine through a plurality of heat exchangers using cryogenic LH₂ fuel as a heat sink.

4. The system of claim 1, wherein the fuel is cryogenic LH₂ fuel, and further where the fuel is configured to be used as a heat sink as the fuel circulates through the plurality of heat exchangers, absorbing heat by at least latent heat of evaporation or increase in the fuel temperature.

5. The system of claim 1, wherein the fuel is mixed with air upon exiting the low-pressure turbine and before entering the combustor.

6. The system of claim 1, wherein the hydrogen-fueled supersonic turboramjet engine is configured to provide the optimal performance from Mach 1 up to Mach 5, with acceptable functionality at subsonic speeds.

7. The system of claim 1, wherein, above Mach 3 the precooler reduces stagnation air temperature prior to airflow reaching the compressor.

8. The system of claim 1, wherein airflow is diverted through the precooler above Mach 3, and airflow is diverted around the precooler below Mach 3.

9. A Hydrogen-Fueled Supersonic Turboramjet Engine system comprising:
an inlet;
a combustor;
a fuel storage;
a high-pressure turbine, and a low-pressure turbine;
a compressor;
a first plurality of stream lines configured to circulate a fuel through a first plurality of heat exchangers, wherein the first plurality of stream lines connects the fuel storage to the combustor; and
a second plurality of stream lines configured to circulate a working fluid through a second plurality of heat exchangers, including the first plurality of heat exchangers, at least some positioned in airframes and a precooler, wherein the second plurality of stream lines connects the compressor to the low-pressure and the high-pressure turbines.

10. The system of claim 9, wherein the use of working fluid with at least high latent heat or specific heat enables use of presently available commercialized alloys due to active cooling of the airframe and the engine through the plurality of heat exchangers using the working fluid as a heat sink.

11. The system of claim 9, wherein the cryogenic LH₂ fuel is configured to be used as a heat sink circulating through the plurality of heat exchangers, absorbing heat by at least latent heat of evaporation or increase in the working fluid temperature.

12. The system of claim 9, wherein the engine is configured to provide the optimal performance from Mach 1 up to Mach 5, with acceptable functionality at subsonic speeds.

13. The system of claim 9, wherein airflow is diverted through the precooler above Mach 3, and the airflow is diverted around the precooler below Mach 3.

14. A method of operating a Hydrogen-Fueled Supersonic Turboramjet Engine to be able to fly at supersonic speed up to Mach 5 while developing adequate thrust for subsonic flights comprising the steps of:
bringing the engine to a supersonic speed of a first Mach number greater than 1.0 prior to initial thrust is provided by the engine;
igniting the engine and accelerating to a greater Mach number greater than the first Mach number;
decelerating to a Mach number less than 1.0 and providing thrust from the engine for controlled flight; wherein the engine comprises:
an inlet;
a combustor;
a fuel storage;
a high-pressure turbine and a low-pressure turbine wherein the initial pressure of the high-pressure turbine is greater than the initial pressure of the low-pressure turbine;
a compressor operably attached to the low-pressure turbine; and
a plurality of stream lines configured to circulate cryogenic LH₂ fuel through a plurality of heat exchangers positioned in airframe and a precooler, wherein the plurality of fuel stream lines connects the fuel storage to the low-pressure and high-pressure turbine and the combustor.

15. The method of claim 15, wherein the circulated fuel is cryogenic liquid molecular hydrogen (LH₂).

16. The method of claim 15, wherein the use of cryogenic LH₂ fuel with high latent heat and specific heat enables use of presently available commercialized alloys due to active cooling of the airframe and the engine through the plurality of heat exchangers using the fuel as a heat sink.

17. The method of claim 15, wherein cryogenic LH₂ fuel is configured to be used as a heat sink circulating through the plurality of heat exchangers, absorbing heat by at least latent heat of evaporation or increase in the fuel temperature.

18. The method of claim 15, wherein the precooler reduces stagnation air temperature above Mach 3, before airflow reaches the compressor.

19. The method of claim 15, wherein airflow is diverted through the precooler above Mach 3, and airflow is diverted around the precooler below Mach 3.
